(19) United States
(12) Patent Application Publication
(10) Pub. No.: US 2019/0385546 A1
(43) Pub. Date: Dec. 19, 2019

(54) DISPLAY APPARATUS AND METHOD FOR DRIVING SAME

(71) Applicants: HKC Corporation Limited, Shezhen City, Guangdong (CN); Chongqing HKC Optoelectronics Technology Co., Ltd., Chongqing (CN)

(72) Inventor: Bin QIU, Chongqing (CN)

(73) Assignees: HKC Corporation Limited, Shezhen City, Guangdong (CN); Chongqing HKC Optoelectronics Technology Co., Ltd., Chongqing (CN)

(21) Appl. No.: 15/565,803

(22) PCT Filed: Sep. 4, 2017
(86) PCT No.: PCT/CN2017/100330

§ 371 Date: Oct. 11, 2017

(30) Foreign Application Priority Data
Aug. 25, 2017 (CN) 201710744745.2

(51) Int. Cl. G09G 3/36

(52) U.S. Cl. CPC G09G 3/3614; G09G 2310/08; G09G 3/3648

(57) ABSTRACT

This application provides a display apparatus and a method for driving same. The display apparatus includes: a timing module, configured to indicate a plurality of polarity inversion signals; and a display panel, including: two substrates disposed opposite to each other and a liquid crystal layer between the two substrates; and a plurality of source drive units, connected to the plurality of source lines, where the plurality of source drive units controls, according to the plurality of polarity inversion signals, polarity inversions of the liquid crystals corresponding to the pixel units. The plurality of source drive units corresponds to a plurality of display zones of the display region. The plurality of polarity inversion signals indicates polarity distribution patterns of different types, so that the liquid crystals corresponding to the plurality of display zones perform polarity inversions according to indications of the corresponding polarity inversion signals.

### BACKGROUND

### Technical Field

This application relates to the field of display technologies, and in particular, to a display apparatus and a method for driving same.

### Related Art

The attributes of liquid crystal cells of an active switch-liquid crystal display (TFT-LCD) cannot be always fixed, and remain unchanged at a particular voltage. Otherwise, even if the voltage is eliminated after a long time, the liquid crystal cells cannot rotate due to the change of the electric field to form different gray scales, because the attributes are destroyed. Therefore, the voltage needs to be recovered back every other period of time, to prevent the attributes of the liquid crystal cells from being destroyed.

Therefore, polarity inversion drive methods of different types have been developed. For example, there is a frame inversion method. The method is to inverse, every other frame, the polarity of display data provided to the liquid crystal cells. A column inversion method is to inverse the polarity of display data every other given number of columns of pixels.. Similarly, a row inversion method is to inverse the polarity of display data every other given number of rows of pixels. A dot inversion method is to inverse the polarity of display data every other given number of pixels.

However, each of the polarity inversion methods has an advantage over other inversion methods as well as an inevitable disadvantage. For example, the column inversion method has excellent performance on elimination of data delay of data lines and reduction of power consumption, but may cause a vertical flickering phenomenon, leading to reduction of the image quality. Although the frame inversion method is most power-saving, the image quantity is poorest. The dot inversion method has optimal anti-flickering performance, but has highest power consumption. However, a same polarity control manner is used in all display zones of the display panel at the present stage. Consequently, relatively good balance cannot be achieved among the image quality, the flickering phenomenon, and the operation power consumption.

### SUMMARY

To resolve the foregoing technical problem, an objective of this application is to provide a display apparatus and a method for driving same. By means of implementing different pixel polarity inversions in different display zones, improvements are made in terms of image flickering and operation power consumption.

The objective of this application is achieved and the technical problem of this application is resolved by using the following technical solutions. A display apparatus provided according to this application comprises: a timing module, configured to indicate a plurality of polarity inversion signals; and a display panel, comprising: a first substrate, comprising a display region and a wiring region on a periphery of the display region, wherein a plurality of source lines and a plurality of gate lines are disposed in the display region, and a plurality of pixel units is disposed at intersections between the plurality of source lines and the plurality of gate lines; a second substrate disposed opposite to the first substrate; a liquid crystal layer, disposed between the first substrate and the second substrate, wherein the liquid crystal layer comprises a plurality of liquid crystals disposed corresponding to the pixel units; and a plurality of source drive units, connected to the plurality of source lines, wherein the plurality of source drive units controls, according to the plurality of polarity inversion signals, polarity inversions of the plurality of liquid crystals corresponding to the plurality of pixel units, wherein the plurality of source drive units corresponds to a plurality of display zones of the display region, and the plurality of polarity inversion signals indicates polarity distribution patterns of different types, so that the plurality of liquid crystals corresponding to the plurality of display zones performs polarity inversions according to indications of the corresponding polarity inversion signals.

The technical problem of this application may be further resolved by taking the following technical measures.

In an embodiment of this application, the polarity distribution patterns comprises at least one of column inversion, row inversion, single point inversion, multipoint inversion, or frame inversion.

In an embodiment of this application, the plurality of display zones comprises a plurality of vertically distributed zones of the display region.

In an embodiment of this application, the plurality of display zones comprises a plurality of horizontally distributed zones of the display region.

In an embodiment of this application, sizes of ranges of the plurality of display zones are the same, different, or partially same.

In an embodiment of this application, polarity inversion methods corresponding to the plurality of display zones are the same, different, or partially same.

In an embodiment of this application, each of the plurality of polarity inversion signals corresponds to more than one source drive unit.

In an embodiment of this application, polarity distribution patterns indicated by the plurality of polarity inversion signals in a previous switching time are different from polarity distribution patterns indicated by the plurality of polarity inversion signals in a next switching time within the two switching times.

Another objective of this application is a method for driving a display apparatus, comprising: indicating a plurality of polarity inversion signals by using a timing module, wherein the plurality of polarity inversion signals indicates polarity distribution patterns of different types; and controlling polarity inversions of liquid crystals of different display zones of a display region by using a plurality of source drive units according to the plurality of polarity inversion signals, wherein the plurality of polarity inversion signals indicates the polarity distribution patterns of different types, so that the liquid crystals corresponding to the plurality of display zones perform polarity inversion according to indications of the corresponding polarity inversion signals.

In an embodiment of this application, the polarity distribution patterns comprises at least one of column inversion, row inversion, single point inversion, multipoint inversion, or frame inversion.

In an embodiment of this application, the plurality of display zones comprises a plurality of vertically distributed zones of the display region.

In an embodiment of this application, the plurality of display zones comprises a plurality of horizontally distributed zones of the display region.

In an embodiment of this application, sizes of ranges of the plurality of display zones are the same, different, or partially same.

In an embodiment of this application, each of the plurality of polarity inversion signals corresponds to more than one source drive unit.

In an embodiment of this application, polarity distribution patterns indicated by the plurality of polarity inversion signals in a previous switching time are different from polarity distribution patterns indicated by the plurality of polarity inversion signals in a next switching time within the two switching times.

Still another objective of this application is a display apparatus, comprising: a control module; a timing module, disposed on the control module, and configured to indicate a first polarity inversion signal and a second polarity inversion signal; and a display panel, comprising: a first substrate, comprising a display region and a wiring region on a periphery of the display region, wherein a plurality of source lines and a plurality of gate lines are disposed in the display region, and a plurality of pixel units is disposed at intersections between the plurality of source lines and the plurality of gate lines; a second substrate, disposed opposite to the first substrate; a liquid crystal layer, disposed between the first substrate and the second substrate, wherein the liquid crystal layer comprises a plurality of liquid crystals disposed corresponding to the pixel units and a plurality of source drive units, connected to the plurality of source lines, wherein the plurality of source drive units controls, according to the first polarity inversion signal and the second polarity inversion signal, polarity inversions of the plurality of liquid crystals corresponding to the plurality of pixel units, wherein the plurality of source drive units corresponds to a first display zone and a second display zone of the display region, the first display zone is located on two sides of the display region, the second display zone is located in the middle of the display region, the first polarity inversion signal and the second polarity inversion signal indicate polarity distribution patterns of different types, so that the plurality of liquid crystals corresponding to the first display zone and the second display zone performs polarity inversions according to indications of the corresponding first polarity inversion signal and second polarity inversion signal.

According to this application, different pixel polarity inversions may be implemented in different display zones while maintaining the original manufacturing process requirement and product costs without greatly changing the precondition of an existing production flow, thereby reducing the power consumption while resolving the problem of flickering of the display panel. Because the production flow does not need to be adjusted, there are no special manufacturing process requirement and difficulty. Therefore, costs are not increased, and this application has extraordinary market competitiveness. In addition, the array wiring area does not need to be increased, and this application is applicable to a plurality of current display panel designs, and certainly, is also applicable to the design of a narrow bezel of a panel, and meets the market and technology trends.

### BRIEF DESCRIPTION OF THE DRAWINGS

FIG. 1a is a schematic architectural diagram of an exemplary display apparatus;

FIG. 1b is a schematic diagram of exemplary configuration of pixel units;

FIG. 1c is a schematic diagram of an exemplary polarity column inversion;

FIG. 1d is a schematic diagram of an exemplary polarity row inversion;

FIG. 1e is a schematic diagram of an exemplary polarity dot inversion;

FIG. 2a is a schematic architectural diagram of an embodiment of a display panel according to a method of this application;

FIG. 2b is a schematic indicator diagram of an embodiment of polarity switching of a display panel according to a method of this application; and

FIG. 3 is a schematic diagram of an embodiment of a driving process of a display panel according to a method of this application.

### DETAILED DESCRIPTION

The following embodiments are described with reference to the accompanying drawings, used to exemplify specific embodiments for implementation of this application. Terms about directions mentioned in this application, such as “on”, “below”, “front”, “back”, “left”, “right”, “in”, “out”, and “side surface” merely refer to directions in the accompanying drawings. Therefore, the used terms about directions are used to describe and understand this application, and are not intended to limit this application.

The accompanying drawings and the description are considered to be essentially exemplary, rather than limitative. In the figures, modules with similar structures are represented by using the same reference number. In addition, for understanding and ease of description, the size and the thickness of each component shown in the accompanying drawings are arbitrarily shown, but this application is not limited thereto.

In the accompanying drawings, for clarity, thicknesses of a layer, a film, a panel, a region, and the like are enlarged. In the accompanying drawings, for understanding and ease of description, thicknesses of some layers and regions are enlarged. It should be understood that when a component such as a layer, a film, a region, or a base is described to be “on” “another component”, the component may be directly on the another component, or there may be an intermediate component.

In addition, throughout this specification, unless otherwise explicitly described to have an opposite meaning, the word “include” is understood as including the component, but not excluding any other component. In addition, throughout this specification, “on” means that one is located above or below a target component and does not necessarily mean that one is located on the top based on a gravity direction.

To further describe the technical means used in this application to achieve the application objective and effects thereof, specific implementations, structures, features, and effects of a display apparatus and a method for driving same provided according to this application are described in detail below with reference to the drawings and preferred embodiments.

A display panel of this application may include a first substrate and a second substrate. The first substrate and the second substrate may be, for example, an active array switch (Thin Film Transistor, TFT) substrate and a color filter (Color Filter, CF) substrate. However, this application is not limited thereto. In some embodiments, an active array switch and a color filter of this application may be formed on a same substrate.

In some embodiments, the display panel of this application may be, for example, a liquid crystal display panel. However, this application is not limited thereto. The display panel may alternatively be an OLED display panel, a W-OLED display panel, a QLED display panel, a plasma display panel, a curved-surface display panel, or a display panel of another type.

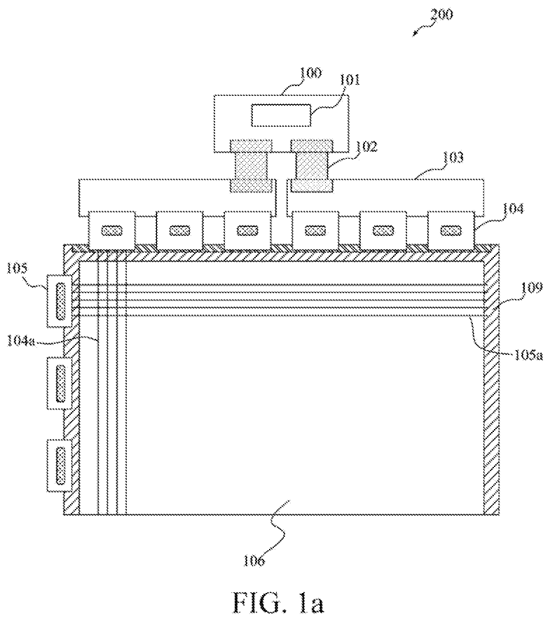

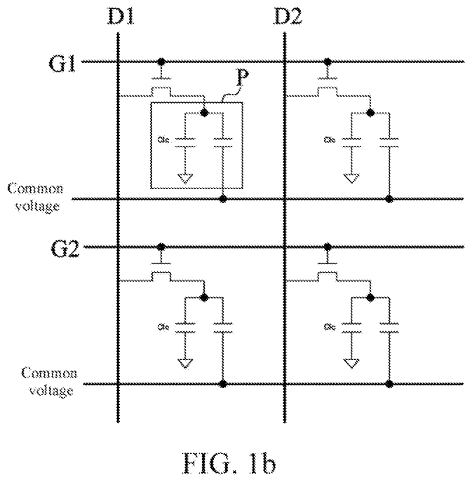

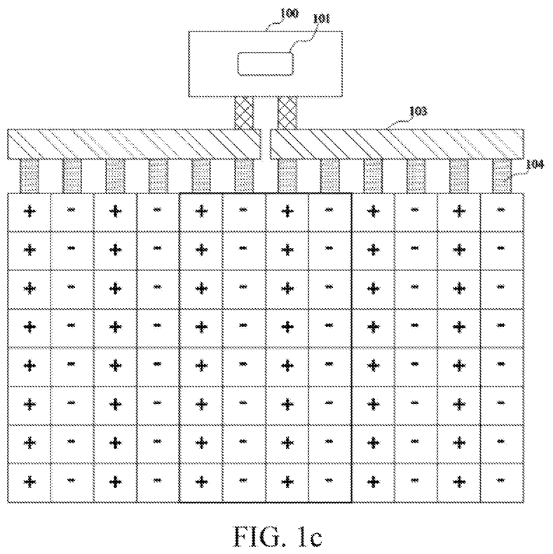

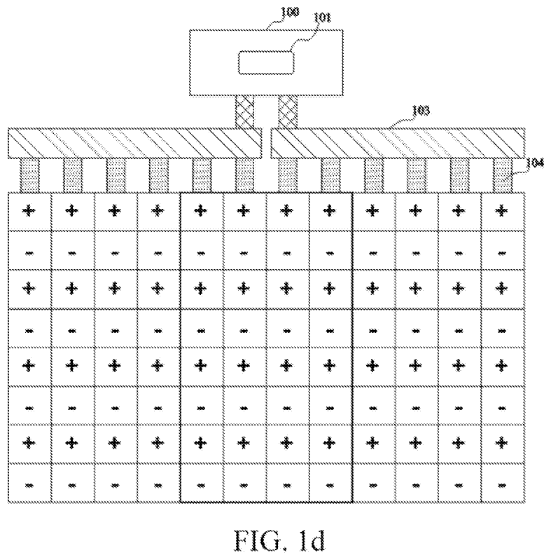

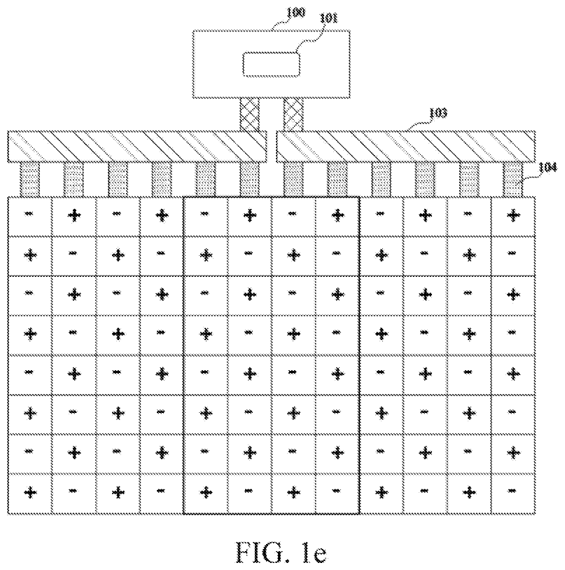

FIG. 1a is a schematic architectural diagram of an exemplary display apparatus. Referring to FIG. 1a, a display apparatus 200 includes: a control module 100, including a timing module (TCON) 101: and a printed circuit board 103, connected to the control module 100 by using a flexible flat cable (FFC) 102. A source drive unit 104 and a gate drive unit 105 are respectively connected to data lines 104a and gate lines 105a in a display region 106. In some embodiments, the gate drive unit 105 and the source drive unit 104 include but are not limited to chip-on-film forms.

FIG. 1b is a schematic diagram of exemplary configuration of pixel units. Dn is a source line 104a. Gn is a gate line 105a. Pixel units P are disposed at intersections between a plurality of source lines 104a and a plurality of gate lines 105a.

FIG. 1c is a schematic diagram of an exemplary polarity column inversion. FIG. 1d is a schematic diagram of an exemplary polarity row inversion. FIG. 1e is a schematic diagram of an exemplary polarity dot inversion. Refer to FIG. 1a for ease of understanding. The gate drive unit 105 provides scanning signals to the gate lines 105a row by row, and provides a scanning signal to one row of the gate lines 105a in each scanning period. For example, the gate drive unit 105 provides a scanning signal to a gate line GI in a period T1, provides a scanning signal to a gate line G2 in a period T2, provides a scanning signal to a gate line G3 in a period T3, and provides a scanning signal to a gate line G4 in a period T4. Data lines of the display panel are opened row by row. The source drive unit provides data to the pixel units P by using the data lines.

As shown in FIG. 1c, a column inversion method is to inverse the polarity of display data every other given number of columns of pixels. As shown in FIG. 1d, a row inversion method is to inverse the polarity of display data every other given number of rows of pixels. As shown in FIG. 1e, a dot inversion method is to inverse the polarity of display data every other given number of pixels. However, a same polarity control manner is used in all display zones of the display panel at the present stage. Consequently, relatively good balance cannot be achieved among the image quality, the flickering phenomenon, and the operation power consumption.

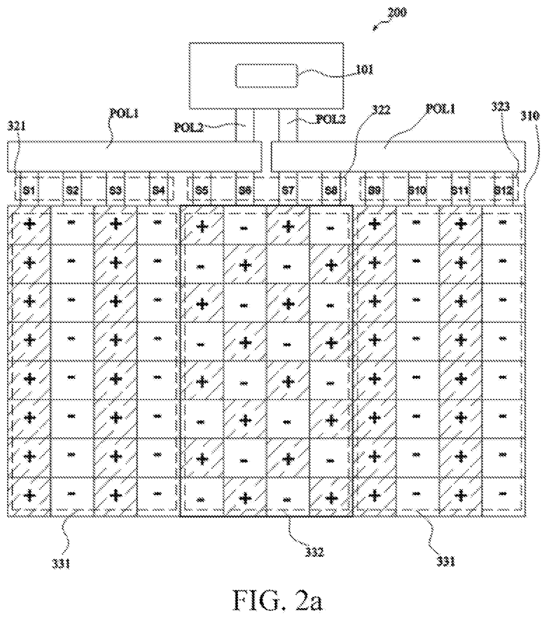

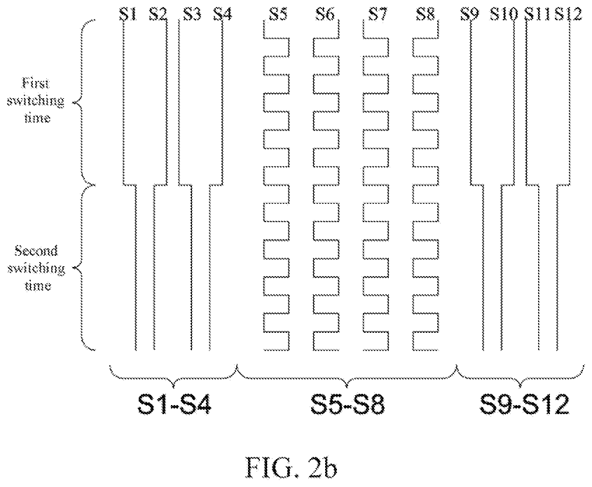

FIG. 2a is a schematic architectural diagram of an embodiment of a display panel according to a method of this application. Refer to FIG. 1a to FIG. 1c for ease of understanding of the related part and the structure. Referring to FIG. 2a, in an embodiment of this application, a display apparatus 200 includes: a first substrate 310, including a display region 106 and a wiring region 109 on a periphery of the display region 106, where a plurality of source lines 104a and a plurality of gate lines 105a are disposed in the display region 106, and a plurality of pixel units P is disposed at intersections between the plurality of source lines 104a and the plurality of gate lines 105a; a second substrate (not shown in the figure), disposed opposite to the first substrate 310: a liquid crystal layer (not shown in the figure), disposed between the first substrate 310 and the second substrate, where the liquid crystal layer includes a plurality of liquid crystals disposed corresponding to the pixel units P; a timing module 101, configured to indicate a plurality of polarity inversion signals (POL); and a plurality of source drive units 104, connected to the plurality of source lines 104a, where the plurality of source drive units (S1 to S12, equivalent to the component 104 in FIG. 1a) controls, according to the plurality of polarity inversion signals, polarity inversions of the plurality of liquid crystals corresponding to the plurality of pixel units P. The plurality of source drive units 104 corresponds to a plurality of display zones of the display region 106, and the plurality of polarity inversion signals (POL) indicates polarity distribution patterns of different types, so that the plurality of liquid crystals corresponding to the plurality of display zones performs polarity inversions according to indications of the corresponding polarity inversion signals.

FIG. 2b is a schematic indicator diagram of an embodiment of polarity switching of a display panel according to a method of this application. Refer to FIG. 2a for ease of understanding. In some embodiments, the plurality of source drive units is divided into a plurality of groups. The plurality of groups includes but is not limited to a first group 321, a second group 322, and a third group 323. By using that there are 12 source drive units as an example, the first group 321 includes a source drive unit S to a source drive unit S4; the second group 322 includes a source drive unit S5 to a source drive unit S8; the third group 323 includes a source drive unit S9 to a source drive unit S12. In an embodiment of this application, the plurality of display zones includes a plurality of vertically distributed zones of the display area 106. A first display zone 331 is located on two sides of the display region 106. A second display zone 332 is located in the middle of the display region. The second group 322 corresponds to the second display zone 332. The first group 321 and the third group 323 correspond to the first display zone 331. In some embodiments, a first polarity inversion signal POL1 indicates a polarity distribution pattern of column inversion; a second polarity inversion signal POL2 indicates a polarity distribution pattern of dot inversion. Therefore, a liquid crystal corresponding to the first display zone 331 presents column inversion polarity switching, and a liquid crystal corresponding to the second display zone 332 presents dot inversion polarity switching.

In some embodiments, the polarity distribution patterns of different display zones comprises at least one of column inversion, row inversion, single point inversion, multipoint inversion, or frame inversion.

In some embodiments, polarity inversion methods corresponding to the plurality of display zones are the same, different or, partially same.

In some embodiments, the plurality of display zones includes a plurality of horizontally distributed zones of the display region.

In some embodiments, the sizes of ranges of the plurality of display zones are the same, different, or partially same.

In some embodiments, each of the plurality of polarity inversion signals corresponds to more than one source drive unit.

In some embodiments, polarity distribution patterns indicated by the plurality of polarity inversion signals in a previous switching time are different from polarity distribution patterns indicated by the plurality of polarity inversion signals in a next switching time within the two switching times. For example, in the previous switching time, the polarity distribution pattern is a polarity row inversion switching mode, and in the next switching time, the polarity distribution pattern is adjusted to a polarity column inversion switching mode.

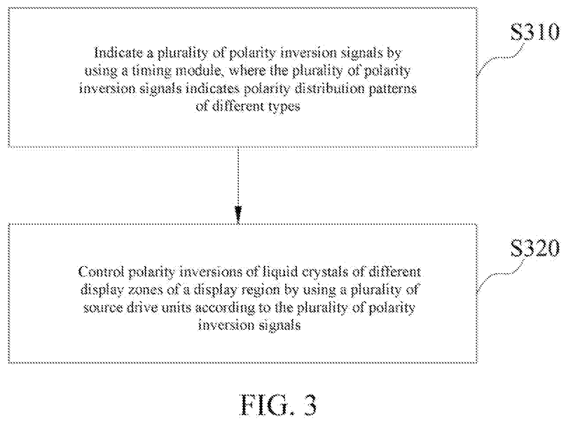

FIG. 3 is a schematic diagram of an embodiment of a driving process of a display panel according to a method of this application. In an embodiment of this application, a method for driving a display apparatus of this application includes:

Step S310: Indicate a plurality of polarity inversion signals by using a timing module 101, where the plurality of polarity inversion signals (POL1, POL2) indicates polarity distribution patterns of different types.

Step S320: Control polarity inversions of liquid crystals of different display zones (331, 332) of a display region 106 by using a plurality of source drive units 104 according to the plurality of polarity inversion signals (POL1, POL2). The plurality of polarity inversion signals (POL1, POL2) indicates the polarity distribution patterns of different types, so that the liquid crystals corresponding to the plurality of display zones perform polarity inversions according to indications of the corresponding polarity inversion signals.

In an embodiment of this application, a display apparatus 200 includes: a control module 100; a display panel, including: a first substrate 310, including a display region 106 and a wiring region 109 on a periphery of the display region 106, where a plurality of source lines 104a and a plurality of gate lines 105a are disposed in the display region 106, and a plurality of pixel units P is disposed at intersections between the plurality of source lines 104a and the plurality of gate lines 105a; a second substrate (not shown in the figure), disposed opposite to the first substrate 310: a liquid crystal layer (not shown in the figure), disposed between the first substrate 310 and the second substrate, where the liquid crystal layer includes a plurality of liquid crystals disposed corresponding to the pixel units P; a timing, module, configured to indicate a first polarity inversion signal POL1 and a second polarity inversion signal POL2; and a plurality of source drive units (S1 to S12) (equivalent to 104 in FIG. 1a), connected to the plurality of source lines 104a, where the plurality of source drive units 104 controls, according to the first polarity inversion signal POL1 and the second polarity inversion signal POL2, polarity inversions of the plurality of liquid crystals corresponding to the plurality of pixel units P. The plurality of source drive units S1 to S12) corresponds to a first display zone 331 and a second display zone 332 of the display region 106. The first display zone 331 is located on two sides of the display region 106. The second display zone 332 is located in the middle of the display region 106 The first polarity inversion signal POL1 and the second polarity inversion signal POL2 indicate polarity distribution patterns of different types, so that the plurality of liquid crystals corresponding to the first display zone 331 and the second display zone 332 performs polarity inversions according to indications of the corresponding first polarity inversion signal POL1 and second polarity inversion signal POL2.

According to this application, different pixel polarity inversions may be implemented in different display zones while maintaining the original manufacturing process requirement and product costs without greatly changing the precondition of an existing production flow, thereby reducing the power consumption while resolving the problem of flickering of the display panel. Because the production flow does not need to be adjusted, there are no special manufacturing process requirement and difficulty. Therefore, costs are not increased, and this application has extraordinary market competitiveness. In addition, the array wiring area does not need to be increased, and this application is applicable to a plurality of current display panel designs, and certainly, is also applicable to the design of a narrow bezel of a panel, and meets the market and technology trends.

The wordings such as “in some embodiments” and “in various embodiments” are repeatedly used. They usually do not refer to a same embodiment; but they may refer to a same embodiment. The words, such as “comprise”, “have”, and “include”, are synonyms, unless other meanings are indicated in the context thereof.

The foregoing descriptions are merely specific embodiments of this application, and are not intended to limit this application in any form. Although this application has been disclosed above through the specific embodiments, the embodiments are not intended to limit this application. Any person skilled in the art can make some variations or modifications, namely, equivalent changes, according to the foregoing disclosed technical content to obtain equivalent embodiments without departing from the scope of the technical solutions of this application. Any simple amendment, equivalent change, or modification made to the foregoing embodiments according to the technical essence of this application without departing from the content of the technical solutions of this application shall fall within the scope of the technical solutions of this application.

What is claimed is:

1. A display apparatus, comprising:
a timing module, configured to indicate a plurality of polarity inversion signals; and
a display panel, comprising:
a first substrate, comprising a display region and a wiring region on a periphery of the display region, wherein a plurality of source lines and a plurality of gate lines are disposed in the display region, and a plurality of pixel units is disposed at intersections between the plurality of source lines and the plurality of gate lines;
a second substrate, disposed opposite to the first substrate;
a liquid crystal layer, disposed between the first substrate and the second substrate, wherein the liquid crystal layer comprises a plurality of liquid crystals disposed corresponding to the pixel units; and
a plurality of source drive units, connected to the plurality of source lines, wherein the plurality of source drive units controls, according to the plurality of polarity inversion signals, polarity inversions of the plurality of liquid crystals corresponding to the plurality of pixel units, wherein
the plurality of source drive units corresponds to a plurality of display zones of the display region, and the plurality of polarity inversion signals indicates polarity distribution patterns of different types, so that the plurality of liquid crystals corresponding to the plurality of display zones performs polarity inversions according to indications of the corresponding polarity inversion signals.

2. The display apparatus according to claim 1, wherein the polarity distribution patterns comprises at least one of column inversion, row inversion, single point inversion, multipoint inversion, or frame inversion,

3. The display apparatus according to claim 1, wherein the plurality of display zones comprises a plurality of vertically distributed zones of the display region.

4. The display apparatus according to claim 1, wherein the plurality of display zones comprises a plurality of horizontally distributed zones of the display region.

5. The display apparatus according to claim I, wherein sizes of ranges of the plurality of display zones are the same.

6. The display apparatus according to claim ; wherein sizes of ranges of the plurality of display zones are different.

7. The display apparatus according to claim 1, wherein sizes of ranges of the plurality of display zones are partially same.

8. The display apparatus according to claim 1, wherein polarity inversion methods corresponding to the plurality of display zones are the same.

9. The display apparatus according to claim 1, wherein polarity inversion methods corresponding to the plurality of display zones are different.

10. The display apparatus according to claim 1, wherein polarity inversion methods corresponding to the plurality of display zones are partially same.

11. The display apparatus according to claim 1, wherein each of the plurality of polarity inversion signals corresponds to more than one source drive unit.

12. The display apparatus according to claim 1, wherein polarity distribution patterns indicated by the plurality of polarity inversion signals in a previous switching time are different from polarity distribution patterns indicated by the plurality of polarity inversion signals in a next, switching time within the two switching times.

13. A method for driving a display apparatus, comprising:
indicating a plurality of polarity inversion signals by using a timing module, wherein the plurality of polarity inversion, signals indicates polarity distribution patterns of different types; and
controlling polarity inversions of liquid crystals of different display zones of a display region by using a plurality of source drive units according to the plurality of polarity inversion signals, wherein the plurality of polarity inversion signals indicates the polarity distribution patterns of different types, so that the liquid crystals corresponding to the plurality of display zones perform polarity inversion according to indications of the corresponding polarity inversion signals.

14. The method for driving a display apparatus according to claim 13, wherein the polarity distribution patterns comprises at least one of column inversion, row inversion, single point inversion, multipoint inversion, or frame inversion.

15. The method for driving a display apparatus according to claim 13, wherein the plurality of display zones comprises a plurality of vertically distributed zones of the display region.

16. The method for driving a display apparatus according to claim 13, wherein the plurality of display zones comprises a plurality of horizontally distributed zones of the display region.

17. The method for driving a display apparatus according to claim 13, wherein sizes of ranges of the plurality of display zones are the same, different, or partially same.

18. The method for driving a display apparatus according to claim 13, wherein each of the plurality of polarity inversion signals corresponds to more than one source drive unit.

19. The method for driving a display apparatus according to claim 13, wherein polarity distribution patterns indicated by the plurality of polarity inversion signals in a previous switching time are different from polarity distribution patterns indicated by the plurality of polarity inversion signals in a next switching time within the two switching times.

20. A display apparatus, comprising:
a control module:
a timing module, disposed on the control module, and configured to indicate a first polarity inversion signal and a second polarity inversion signal; and
a display panel, comprising:
a first substrate, comprising a display region and a wiring region on a periphery of the display region, wherein a plurality of source lines and a plurality of gate lines are disposed in the display region, and a plurality of pixel units is disposed at intersections between the plurality of source lines and the plurality of gate lines;
a second substrate, disposed opposite to the first substrate;
a liquid crystal layer, disposed between the first substrate and the second substrate, wherein the liquid crystal layer comprises a plurality of liquid crystals disposed corresponding to the pixel units; and
a plurality of source drive units, connected to the plurality of source lines, wherein the plurality of source drive units controls., according to the first polarity inversion signal and the second polarity inversion signal, polarity inversions of the plurality of liquid crystals corresponding to the plurality of pixel units, wherein
the plurality of source drive units corresponds to a first display zone and a second display zone of the display region, the first display zone is located on two sides of the display region, the second display zone is located in the middle of the display region, the first polarity inversion signal and the second polarity inversion signal indicate polarity distribution patterns of different types, so that the plurality of liquid crystals corresponding to the first display zone and the second display zone performs polarity inversions according to indications of the corresponding first polarity inversion signal and second polarity inversion signal.
